(19) United States
(12) Patent Application Publication
(10) Pub. No.: US 2026/0017535 A1
(43) Pub. Date: Jan. 15, 2026

(54) CYCLIC BEHAVIOR DETECTION IN GENERATIVE AGENTS

(71) Applicant: Microsoft Technology Licensing, LLC, Redmond, WA (US)

(72) Inventors: Benjamin Eliot LUNDELL, Seattle, WA (US); Shannon Richard Monroe, Redmond, WA (US); Mollie Elizabeth Munoz, Redmond, WA (US); Natalie Isak, Cambridge, MA (US); Ernest Booth, Vashon, WA (US)

(21) Appl. No.: 18/773,455

(22) Filed: Jul. 15, 2024

(51) Int. Cl. G06N 5/02

(52) U.S. Cl. CPC G06N 5/02

(57) ABSTRACT

Systems, devices, methods, and computer-readable media for cycle detection in generative agent responses are provided. A method includes receiving, from the generative agent, a candidate completion, the candidate completion including a first response to a message from an entity conducting a conversation with the generative agent, determining, by a semantic extractor, a semantic embedding of the first response, and determining, by a cycle detector and based on the embedding and prior embeddings, whether the first response is a repetition of a prior candidate completion in the conversation.

### TECHNICAL FIELD

Embodiments regard detecting cyclic behavior in generative agents.

### BACKGROUND

A typical generative chat agent receives a prompt and then generates a completion to the prompt in an attempt to complete a task indicated by the prompt. Cyclical behavior among generative agents is an ongoing problem. The problem is concerning for software developers and users of generative artificial intelligence (AI). A generative agent may exhibit cyclic behavior in some circumstances. The cyclic behavior may include repetitive completions (responses from a generative agent), apologizing to the user or another human or generative agent, or it could repeatedly invoke a same function. Invoking a same function cause the agent to become stuck scrolling on a screen instead of using a search bar. The results of this cyclic behavior can cause an irritant to the user and even result in a user blocking progress on a task.

One approach for cyclic behavior detection being used currently is to use a large language model (LLM) to observe and report on any cyclical behavior by a generative agent. This is slow due to the high computation costs of the LLM and less reliable as the generative agent is prone to variability in completions. Additionally, the prompt used for an LLM for cycle detection retrieves limited information, pertaining only to the task in question. Thus, such an LLM prompt is not widely applicable.

### SUMMARY

A method, system, device, interface, means for, and computer-readable medium that detect cyclic behavior in generative agents is provided. A method includes receiving, from the generative agent, a candidate completion, the candidate completion including a first response to a message from an entity conducting a conversation with the generative agent. The method can further include determining, by a semantic extractor, a semantic embedding of the first response. The method can further include determining, by a cycle detector and based on the semantic embedding and prior embeddings, whether the first response is a repetition of a prior candidate completion in the conversation.

The method can further include responsive to determining the first response is the repetition, performing a mitigation action. The mitigation action can include generating a prompt and providing the prompt to the generative agent, the prompt engineered to cause the generative agent to produce a second response that is not a repetition. The entity can be another generative agent or a user device.

The method can further include identifying that the first response includes a function call. The method can further include incrementing a counter associated with a function of the function call. The method can further include determining the first response is a repetition if the counter is greater than a threshold value.

The cycle detector can be a trained machine learning (ML) model trained based on labelled conversation histories with generative agents. The method can further include storing the semantic embedding in a semantic embedding database and wherein the cycle detector determines respective distances between the semantic embedding and prior semantic embeddings stored in the embedding database and determines the semantic embedding is the repetition if any of the respective distances satisfies a distance criterion.

The distance criterion can be greater than a specified first threshold when the distance is a cosine similarity or can be less than a specified second threshold when the distance is an angular distance. The semantic extractor can determine multiple semantic embeddings for the first response, the multiple semantic embeddings including semantic embeddings for different length portions of the first response.

A machine-readable medium can include instructions that, when executed by a machine, cause the machine to perform operations for cycle detection in responses from a generative agent, the operations comprising receiving, from the generative agent, a candidate completion, the candidate completion including a first response to a message from an entity conducting a conversation with the generative agent. The operations can further include determining a semantic embedding of the first response, the semantic embedding including a projection of the first response to a semantic space in which semantically similar language is closer to each other than semantically different language. The operations can further include determining, based on the semantic embedding, whether the response is a repetition of a prior candidate completion in the conversation. The operations can further include performing a mitigation action responsive to determining the response is the repetition.

A system for cycle detection in responses from a generative agent can include processing circuitry and at least one memory, the memory including instructions that, when executed by the processing circuitry, cause the processing circuitry to implement: a semantic extractor configured to generate a semantic embedding of a first response from the generative agent during a conversation, the semantic embedding including a projection of the first response to a semantic space in which semantically similar language is closer than semantically different language, and a cycle detector configured to receive the semantic embedding and determine, based on the semantic embedding, whether the response is a repetition of a prior candidate completion in the conversation.

### BRIEF DESCRIPTION OF DRA WINGS

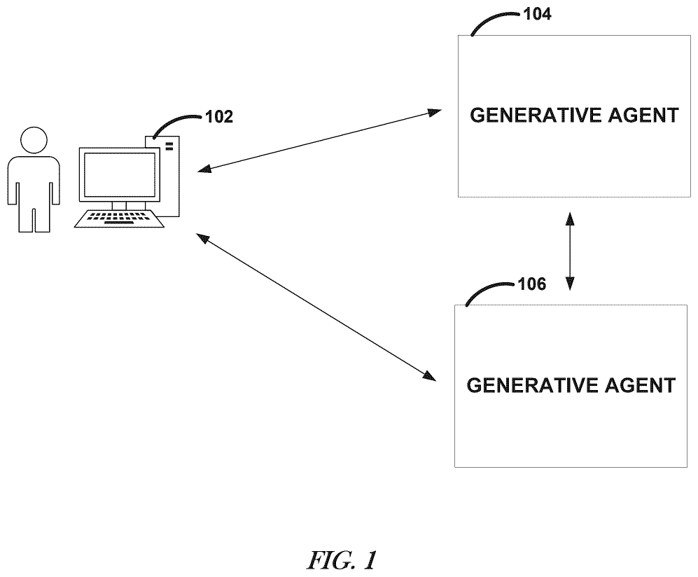

FIG. 1 illustrates, by way of example, a diagram of an embodiment of a system.

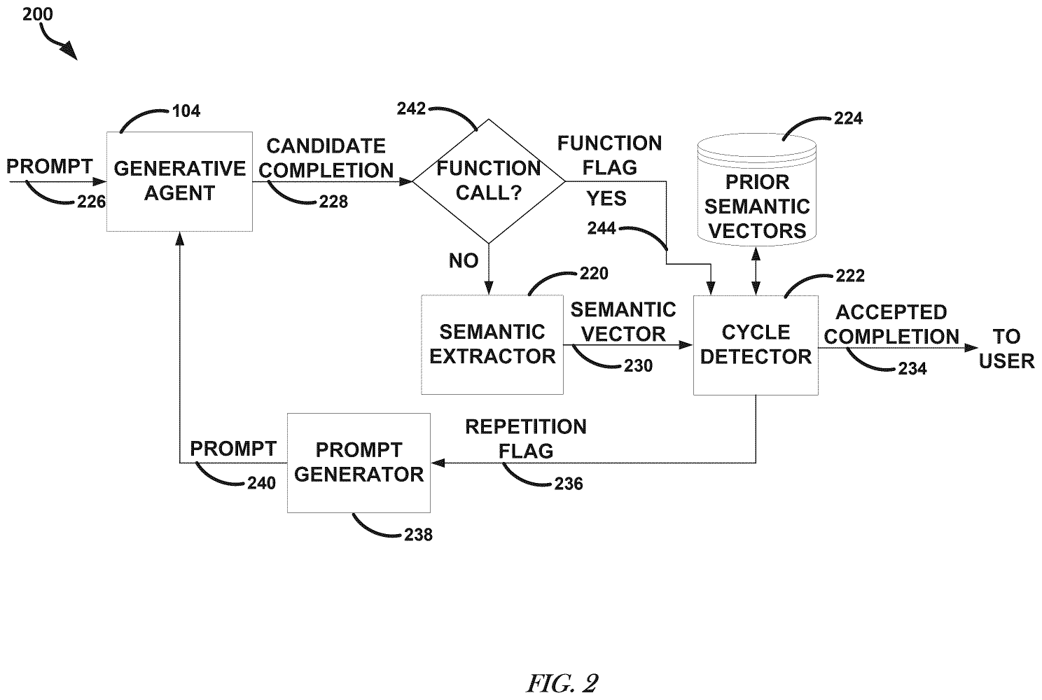

FIG. 2 illustrates, by way of example, a diagram of an embodiment of a system for detecting a repetition or cycle in generative agent output.

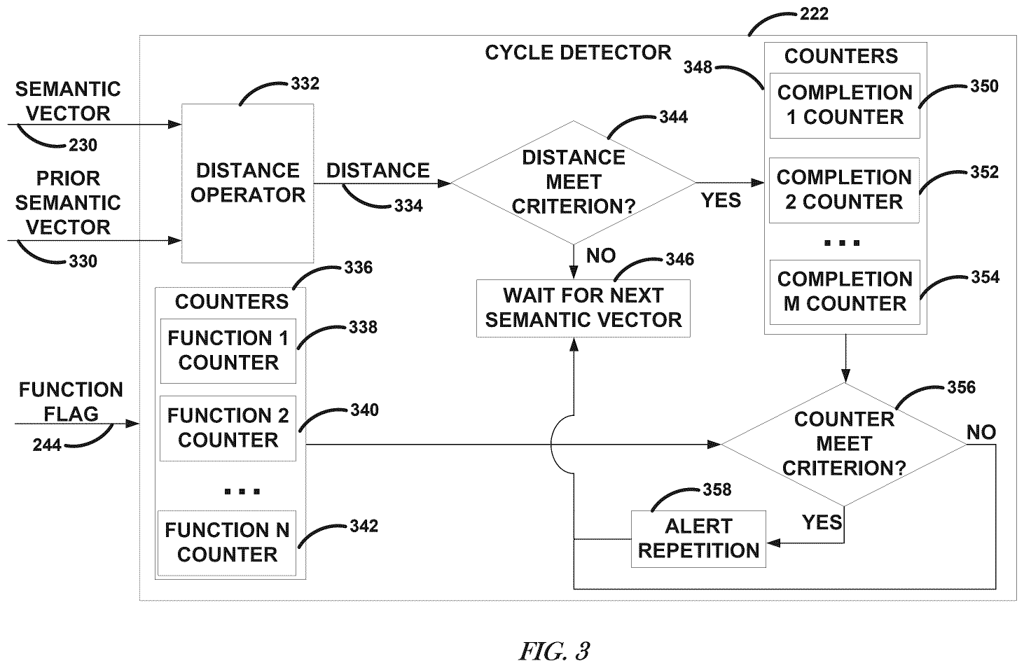

FIG. 3 illustrates, by way of example, a graph of embedding versus time for output of a generative agent.

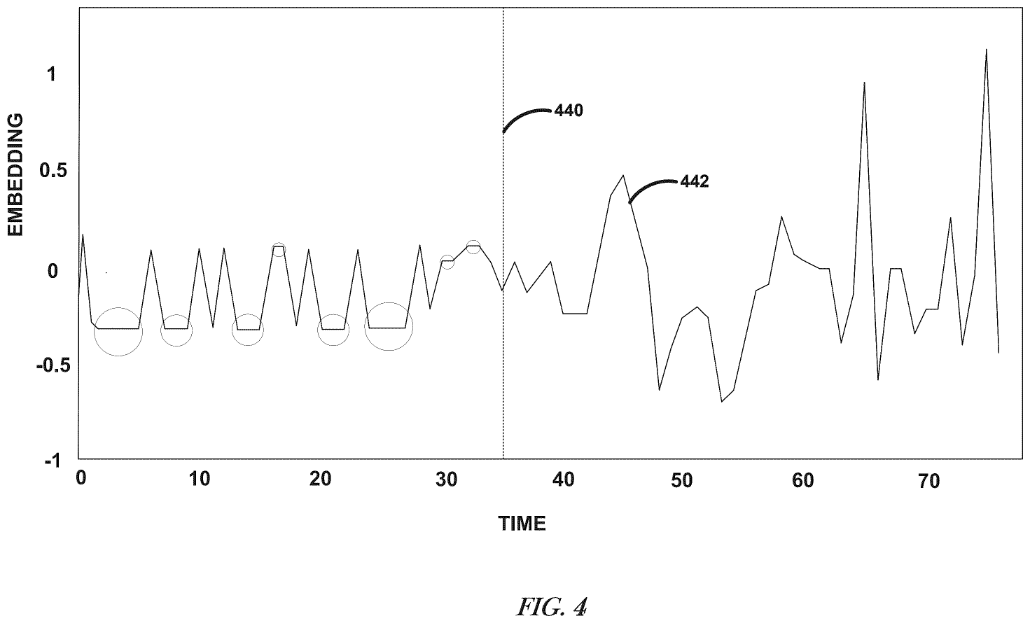

FIG. 4 illustrates, by way of example, a diagram of an embodiment of a method for cyclic behavior detection in a generative agent.

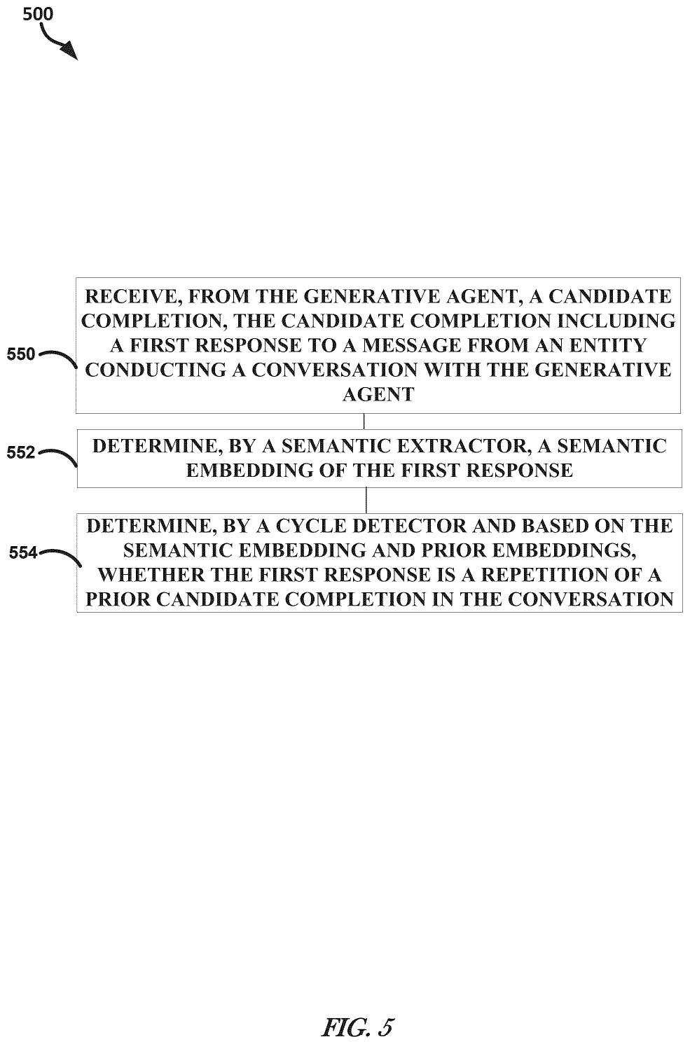

FIG. 5 is a block diagram of an example of an environment including a system for neural network (NN) training.

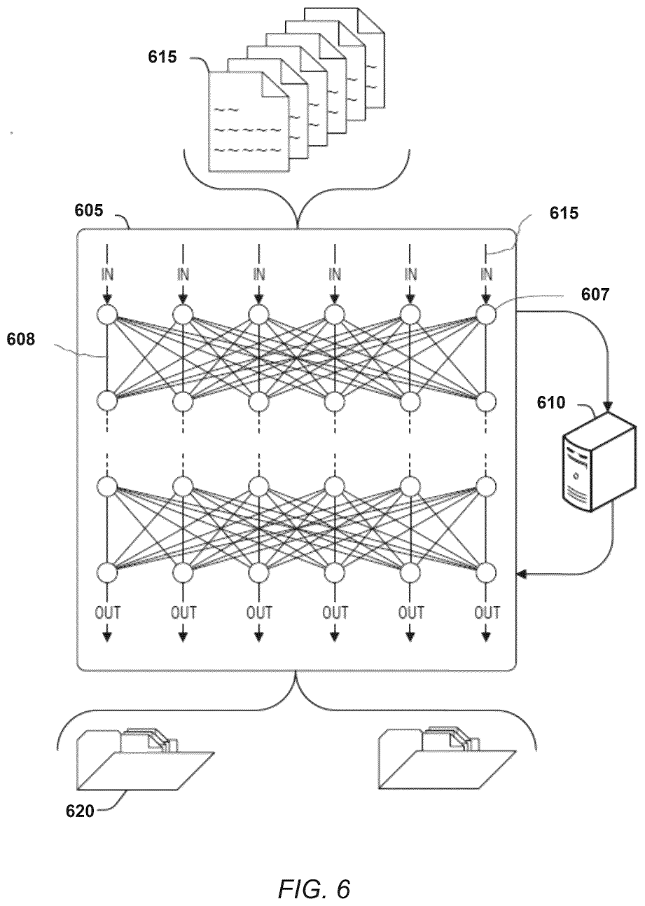

FIG. 6 illustrates, by way of example, a block diagram of an embodiment of a machine in the example form of a computer system within which instructions, for causing the machine to perform any one or more of the methods or techniques discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Cyclic behavior detection in a generative agent in an automated reliable manner is provided. Cyclic behavior detection detects cyclical or repetitive responses from the generative agent. Cyclical or repetitive is defined herein as semantically similar and repetitive. The level of semantic similarity is use-case dependent. The manner of detecting semantic similarity is flexible and also use-case dependent but can include using embeddings of responses from the generative agent. Note that responses from the generative agent are also referred to as “completions” because the nature of a generative agent is to predict next words that follow a prompt that was provided as an input to the generative agent. Cyclic behavior can be detected and alerted. Such cyclic detection can assist software developers in testing products and can be used as part of the next step in mitigation of the behavior.

Embeddings can be used for a determined portion of a completion from a generative agent. This completion may be viewable by the user in a conversation or could be within the agent system software and not ever seen by the user, (e.g., code to be executed). Each embedding can be cached (e.g., for a specified period). A next embedding can be compared to prior embeddings and flagged as repetitive if specific criterion are met. Alternative to specified criterion a machine learning (ML) model can be trained in a supervised manner to detect cyclic or anomalous behavior. The criterion can include a cosine similarity or angular distance calculation made on an embedding of interest relative to other embeddings in a determined completion-window of interest. The completion-window includes a specified number of prior embeddings and is configurable. If a measurement reaches a determined threshold for the specific scenario, the qualifying completions associated with those “similar” embeddings would be identified as repetitive. How cyclic behavior is alerted is system dependent. For a developer, alerting may include highlighting of the “similar” statements with an alert visual. For an end-user experience, alerting may come up as a question to the user to confirm that behavior was desired or expected. The product and use case will determine the best way to receive an alert message so that the information on what is repeating can be used.

Embedding retrieval from an embeddings-model is faster than receiving a response to a prompt from a generative agent. An embedding is deterministic with a small, if any, variability on sequences of same tokens. Also, a cosine similarity calculation, angular distance calculation, or ML model classification are also faster than a retrieval from a generative agent. As a result, not only is the calculation and discovery of repetitive behavior over a typical conversation or activity window fast, it is also reliable.

By retrieving, caching, and comparing embeddings, discovery of similar statements can have other utility beyond cycle detection. By retrieving, caching, and comparing embeddings and the information is now stored and can be processed locally instead of prompting an LLM for an analysis. This provides a way to understand a current state of the conversation or a current state of completion behavior of the generative agent.

FIG. 1 illustrates, by way of example, a diagram of an embodiment of a system 100. The system 100 includes a user device 102 and multiple generative agents 104, 106. The user device 102 connects to an application programming interface (API) that interfaces with one or more the generative agents 104, 106.

The generative agent 104, 106 can be a generative large language model (LLM), a model that is instruction-tuned to converse with a human user, a foundational generative AI model, such as a small language model (SLM), multimodal vison-language model, or the like. LLMs are computational models that are trained to take text as input and predict a next word or token. Examples of generative agents include the GPT series of models from OpenAI, such as GPT-3, GPT-3.5, GPT-4, or Gemini, LLaMa, and Claude, among others, from other entities. SLMs are similar to LLMs but consume less memory and typically operate to make decisions faster than LLMs. For example, LLMs typically include trillions of parameters while SLMs include billions of parameters. Mistral 7B is an example SLM. Examples of multimodal vision-language model include Contrast Language-Image Pretraining and Vision-and-Language BERT.

The user device 102 supplies a prompt to one or more of the generative agents 104, 106. The prompt indicates a task to be performed by the generative agents 104, 106. The prompt can ask the generative agents 104, 106 for data, data analysis, code generation, text generation, or the like. The prompt can ask the generative agents 104, 106 to collaborate to perform a task. The prompt can indicate a role for the generative agent in performing the task. Example roles include software developer, project manager, database manager, user interface (UI) developer, among many others. The prompt, for example, can ask the generative agents 104, 106 to collaborate in developing a software application.

The generative agents 104, 106 can issue output (sometimes called) responses to the prompt or further messages from the user 102 or the other generative agent 106, 104. The output from the generative agents 104, 106 can become repetitive or cyclic in some circumstances. The repetitive output can include repetition of the same response, repetition of a series of consecutive responses, or the like. The repetition, in some instances can be desired, but in other instances the repetition is problematic. The repetitions that are problematic are called “bad repetitions”. Detecting the repetition or cycle in a fast, reliable way is not trivial.

FIG. 2 illustrates, by way of example, a diagram of an embodiment of a system 200 for detecting a repetition or cycle in generative agent output. The system 200 as illustrated includes a generative agent 104, a semantic extractor 220, a cycle detector 222, and a prior semantic vectors database 224. The generative agent 104 receives a prompt 226 or a message from a user device or another generative agent. The generative agent 104 generates a candidate completion 228. The candidate completion 228 is an answer to the prompt 226 or message. The candidate completion 228 is a series of words or tokens that the generative agent 104 predicts will follow the prompt 226 or the message.

A prompt or message can include a natural language description engineered to cause the agent to perform a task or update the agent. The prompt can be provided by a user or another generative agent. The natural language description can be converted to a series of tokens. The series of tokens thus represents a natural language series of words. The series of tokens is generated by a process known as tokenization. Tokenization is the process of converting a sequence of text into smaller parts, known as tokens. The tokens can represent characters, words, or some other unit of natural language text. Tokenization helps machines understand human language by breaking the natural language text into a format that is easier for the machine to understand. A goal of tokenization is to represent text in a manner that is meaningful for a machine without losing the context of the associated natural language. With language in token form, a machine can more readily identify a pattern in the associated natural language. Example tokenization techniques include natural language toolkit (NLTK), Spacy, Keras Tokenizer, and bidirectional encoder representations from transformers (BERT) tokenizer, among others.

The semantic extractor 220 produces a semantic vector 230 based on at least a portion of the candidate completion 228. The semantic vector 230 is a representation of the candidate completion 228 in a semantic space. The semantic space is of a specified dimension. In the semantic space, words or tokens that are more semantically similar are closer to each other than words or tokens that have less semantic similarity. Example techniques that can be implemented by the semantic extractor 220 to generate the semantic vector 230 include Ada 002, E5, embed V3, and BERT, among many others.

The input to the semantic extractor 220 can include less than the whole of the candidate completion 228, all of the candidate completion 228, a portion of a conversation history immediately prior to the candidate completion 228, or a combination thereof. Different length inputs create semantic vectors 230 that are used to detect different cycles. For example, a shorter length input can be used to identify a greeting repetition, a function call repetition, or a repetition that is otherwise shorter than most sentences. A longer length input can be used to identify a sentence repetition, a response repetition, or the like. Not all repetitions are bad or not desired. Some repetitions are warranted and wanted depending the task to be completed by the agent. A bad repetition is one that is not desired and does not progress a conversation being conducted between the agent and a user or another agent.

The semantic vector 230 can be input into a cycle detector 222. The cycle detector 222 determines whether the semantic vector 230 is associated with a repetition or not. In some instances, the cycle detector 222 can determine whether the semantic vector 230 is semantically similar to a prior semantic vector of the prior semantic vectors database 224. The cycle detector 222 can compare the semantic vector 230 to a specified number of the prior semantic vectors. The specified number can be a sliding window over a history of the prior semantic vectors, an entirety of the history of the conversation, or the like.

The semantic extractor 220 can generate multiple semantic vectors 230 based on a single candidate completion 228 or a portion thereof. The semantic extractor 220 can, for example, generate a semantic vector 230 for each of a plurality of input lengths. The cycle detector 222 can then determine if there is a repetition at each of the plurality of input lengths. The prior semantic vectors in the database 224 can be organized by length, temporal recency, a combination thereof, or the like.

In some instances, the database 224 is not needed. Such instances can include a cycle detector 222 that is a trained ML model. The ML model can be trained based on labelled semantic vector histories. The labelled semantic vectors can be organized in conversation order and labelled as “repetitive” or “normal”. The ML model can thus learn features of what is considered repetitive based on this training. The ML model can then receive semantic vectors associated with a conversation and identify semantic vectors associated with repetitive behavior. In some instances, the ML model can be trained based on just normal or just repetitive conversation behavior. The resulting ML model trained on just the normal (non-repetitive) or repetitive behavior can similarly flag any semantic vectors associated with repetitive behavior.

In some instances, the cycle detector 222 can determine a cosine similarity, an angular distance, or other distance, in semantic space. The cycle detector 222 can determine the distance based on the semantic vector 230 and one or more semantic vectors in the database 224. The database 224 can store prior semantic vectors that are known to be associated with cycles, all prior semantic vectors associated with the generative agent, prior semantic vectors from a given conversation, or the like. The distance can be compared to a threshold distance. If the distance is greater than the threshold distance (in the case of cosine similarity) or less than the threshold distance (in the case of angular distance), the semantic vector 230 can be deemed repetitive. The threshold distance can be determined by experiment and is use-case specific. The threshold distance can depend on what a developer believes is a repetition. For example, in one case, a developer may only care about exact or nearly exact repetitions and in such cases fewer responses will be flagged as repetitions and the threshold will be closer to an extrema. In another case, a developer may care about dialogue that is less semantically similar but still same meaning and in such cases more responses will be flagged as repetitions and the threshold will be further from the extrema. The extrema can be “1” in the case of cosine similarity and “0” in the case of angular distance.

If the semantic vector 230 is deemed to not be repetitive (to be “normal”), the candidate completion 228 can be provided as an accepted completion 234. If the semantic vector 230 is deemed to be repetitive, the cycle detector 222 can issue a flag 236 to a prompt generator 238. The flag 236 can indicate that the prompt generator 238 is to generate a prompt 240, or other communication, to the generative agent 104. The prompt 240 can indicate to the generative agent 104 that their response was repetitive. The prompt 240 can further indicate that the generative agent 104 is to respond in a manner that furthers the conversation or progress to complete the task indicated by the prompt 226. The prompt 240 can indicate why the candidate completion 228 is considered repetitive, a relevant portion of the conversation history, or a combination thereof. The generative agent 104 can then produce another candidate completion 228 that is not repetitive or progresses completion of the task.

Many generative agents 104 are able to invoke functions in performing the task indicated by the prompt 226. Another form of repetition can thus be a repeated function call. A function call can show up in the candidate completion 228. Since a function call can have different variables passed thereto, the function call with variables defined may not necessarily be considered semantically similar to the same function call with different defined variables. Thus, if there is a repetitive function call, it may not be flagged by the cycle detector 222. However, in such instances, a function call detector can determine whether the candidate completion 228 includes a function call at operation 242. If the candidate completion 228 does not include a function call, the candidate completion 228 can be provided to the semantic extractor 220. If the candidate completion 228 does include a function call, the candidate completion 228 can be provided to the cycle detector 222 (without being provided to the semantic extractor 220). The cycle detector 222 can determine which function, of the possible functions that can be called by the generative agent 104, is being called. The cycle detector 222 can increment a counter that records how many times the function has been called in a specified number of conversation turns. The number of conversation turns is configurable per the application. Sometimes repeating a function call is expected and not extraordinary. However, sometimes even multiple function calls during a conversation is extraordinary and should be flagged. By separating function calls from text can reduce an amount of work performed by the semantic extractor 220 and can help guarantee that repeated function calls are detected by the cycle detector 222.

FIG. 3 illustrates, by way of example, a diagram of an embodiment of the cycle detector 222. The cycle detector 222 determines whether a given candidate completion is a repetition. The cycle detector 222 provides an alert (e.g., a repetition flag 236 see FIG. 2 or a communication to a user interface) if the candidate completion is a repetition.

The cycle detector 222 receives the semantic vector 230 from the semantic extractor 220 and relevant prior semantic vector(s) 330 from the prior semantic vectors database 224. The cycle detector 222 determines, by a distance operator 332, a distance 334 between the received vectors. At operation 344, the cycle detector 222 determine whether the distance meets a specified criterion. The criterion is user-configurable and application-specific. The distance operator 332 can determine the distance 334 between the vectors 230, 330 in a semantic space. The distance 334 can be, for example, a cosine distance or an angular distance. If the distance 334 meets the criterion a counter 350, 352, 354 of respective counters 348 associated with the semantic vector 230 (the semantic vector 230 is a representation of a candidate completion in a semantic space) is incremented. The counters 348 track how many times a semantically similar candidate completion is provided in a given conversation. If the distance does not meet the criterion, the cycle detector 222 can wait for a next semantic vector input at operation 346.

Function counters 336 track how many times a function is called in a given conversation. Each function that can be called by the generative agent can include a corresponding function counter 338, 340, 342. The counters 336 can receive the function flag 244. The function flag 244 indicates a function was called and which function was called. The counter 338, 340, 342 associated with the function of the function flag 244 is incremented responsive to receiving the flag 244.

At operation 356, the cycle detector 222 determines whether any of the values of any of the counters 336, 348 satisfies specified criterion. The criterion is user-configurable and application-specific. The number of function calls and the number of repeat completions that are acceptable can be the same or different. If the counter meets the criterion, the cycle detector can issue an alert at operation 358. If the counter does not meet the criterion, the cycle detector 222 can perform operation 346.

FIG. 4 illustrates, by way of example, a graph of embedding versus time for output of a generative agent. The graph of FIG. 4 was generated using the system 200 and indicates that repetition can be detected and managed using the system 200. The graph includes a line 442 that represents a normalized location value of the embedding and a vertical line 440 that indicates a point in time that separates the time the generative agent was repeating from the time the generative agent stopped repeating output. The agent is being repetitive is indicated by horizontal portions (or nearly horizontal portions) of the line 442. Perfectly horizontal sections of line mean that the agent is being perfectly repetitive (word for word repetition). Some of the horizontal portions are circled. The repetition of the agent in the instance associated with this graph was broken by prompting the agent to stop repeating and stop apologizing.

Note that detection “repetition” is variable and depends on circumstances of a given use case. Factors that influence what qualifies as a repetition include an actor being monitored for repetition (user or agent) and use of the results (application development or agent optimization). Sometimes it is desired to make it seem like the agent is not being repetitive in the beginning of a sentence (if an agent always says “okay” or another platitude responsive to a user message) and sometimes it is desired to make sure the agent is not being repetitive or cyclical on a sentence level so as to further a conversation.

FIG. 5 illustrates, by way of example, a diagram of an embodiment of a method 500 for cyclic behavior detection in a generative agent. The method 500 includes receiving, from the generative agent, a candidate completion, the candidate completion including a first response to a message from an entity conducting a conversation with the generative agent, at operation 550; determining, by a semantic extractor, a semantic embedding of the first response, at operation 552; and determining, by a cycle detector and based on the semantic embedding and prior embeddings, whether the first response is a repetition of a prior candidate completion in the conversation, at operation 554.

The method 500 can further include responsive to determining the first response is the repetition, performing a mitigation action. The mitigation action can include generating a prompt and providing the prompt to the generative agent, the prompt engineered to cause the generative agent to produce a second response that is not a repetition.

The entity can be another generative agent or a user device. The method 500 can further include identifying that the first response includes a function call. The method 500 can further include incrementing a counter associated with a function of the function call. The method 500 can further include determining the first response is a repetition if the counter is greater than a threshold value.

The cycle detector can be a trained machine learning (ML) model trained based on labelled conversation histories with generative agents. The method 500 can further include storing the semantic embedding in a semantic embedding database and wherein the cycle detector determines respective distances between the semantic embedding and prior semantic embeddings stored in the embedding database and determines the semantic embedding is the repetition if any of the respective distances satisfies a distance criterion.

The distance criterion can be greater than a specified first threshold when the distance is a cosine similarity or can be less than a specified second threshold when the distance is an angular distance. The semantic extractor can determine multiple semantic embeddings for the first response, the multiple semantic embeddings including semantic embeddings for different length portions of the first response.

What follows is a description of an experiment that aids understanding how different sized inputs to a semantic extractor and different distance criterions used by a cycle detector affect what is determined to be repetitive. Consider the following sequences of completions provided from a generative agent in a conversation.

0 I'm sorry, but I don't have access to your past actions or any information about you before this conversation.

1 Of course, I'd be happy to help you figure out what to do today!

2 Sure!

3 That sounds like a great idea!

4 Great, I have added toothpaste from Costco to your shopping list along with the tomatoes, leeks, and mint.

5 I understand.

6 Got it, responding to your friends about the birthday gathering is important.

7 Got it!

8 That's great!\

9 Great, it sounds like you have a busy weekend ahead of you with the gym session and completing your taxes.

10 Sure thing!

11 Of course, I'd be happy to help you make more of Kobe's biscuits.

12 Sure Thing!

13 Great!

14 Got it, thanks for clarifying!

15 Sure!

16 Sure thing!

17 Great to hear that you've decided on a sofa table from Amazon!

18 Based on my training data, the best time to call the IRS is early in the morning, during their less busy hours.

19 Don't worry, there may still be time to call the IRS during their less busy hours.

20 It sounds like a good plan to call the IRS tomorrow morning.

21 Based on our chat history, the only plan you mentioned for tomorrow morning is going to the gym.

22 It sounds like you have another task to add to our list!

23 It sounds like you have a plan to return your item to IKEA on Saturday.

24 It sounds like you have a plan to return your item to IKEA on Saturday.

25 Sure, I can help you keep track of your upcoming appointments.

26 Great, I'd be happy to help you keep track of your appointments!

27 Based on what you've told me, you have a stretch session scheduled for March 31st from 11-1 pm, along with Jacob's hair cut at 1 μm or the 29th and a hair appointment on the 30th at 11 am.

28 No problem, I've updated your appointment schedule to reflect that the stretch session on the 17th is from 11-1?.

When the first sentence provided by the generative agent is provided to the semantic extractor and a cosine similarity threshold of 0.8 is enforced by the cycle detector, the following lines are considered repetitive of each other: lines 2 and 15, lines 10 and 12, lines 10 and 16, lines 12 and 16, lines 23 and 24, and lines 25 and 26.

When the first sentence provided by the generative agent is provided to the semantic extractor and a cosine similarity threshold of 0.6 is enforced by the cycle detector, the following lines are considered repetitive of each other: lines 2 and 10, lines 2 and 12, lines 2 and 15, lines 2 and 16, lines 7 and 14, lines 8 and 13, lines 10 and 12, lines 10 and 15, lines 10 and 16, lines 12 and 15, lines 12 and 16, lines 15 and 16, lines 18 and 19, lines 23 and 24, and lines 25 and 26.

When output of the generative agent up to the first comma or first period is provided to the semantic extractor and a cosine similarity threshold of 0.8 is enforced by the cycle detector, the following lines are considered repetitive of each other: lines 1 and 11, lines 2 and 17, lines 4 and 9, lines 4 and 28, lines 6 and 14, lines 9 and 28, lines 10 and 12, lines 10 and 18, lines 12 and 18, lines 15 and 16, lines 15 and 23, lines 16 and 23, and lines 25 and 26.

When the first sentence provided by the generative agent if the first sentences has 20 or more characters else the first and second sentences is provided to the semantic extractor and a cosine similarity threshold of 0.7 is enforced by the cycle detector, the following lines are considered repetitive of each other: lines 23 and 24, and lines 25 and 26.

When the first sentence provided by the generative agent if the first sentences has 20 or more characters else the first and second sentences is provided to the semantic extractor and a cosine similarity threshold of 0.6 is enforced by the cycle detector, the following lines are considered repetitive of each other: lines 5 and 7, lines 6 and 7, lines 11 and 13, lines 18 and 19, lines 23 and 24, and lines 25 and 26.

AI is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The model 452, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph-if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

FIG. 6 is a block diagram of an example of an environment including a system for neural network (NN) training. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 607 within layers. Thus, a set of processing nodes 610 is arranged to perform the training of the ANN 605. The generative agent 104, semantic extractor 220, cycle detector 222, prompt generator 238, or the like, can be trained using the system.

The set of processing nodes 610 is arranged to receive a training set 615 for the ANN 605. The ANN 605 comprises a set of nodes 607 arranged in layers (illustrated as rows of nodes 607) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 615 to be classified after ANN 605 is trained, is provided to a corresponding node 607 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 615 will be assigned into categories), for example. The training performed by the set of processing nodes 607 is iterative. In an example, each iteration of the training the ANN 805 is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 607 (e.g., neurons) are trained independently. In an example, the nodes are trained on different hardware.

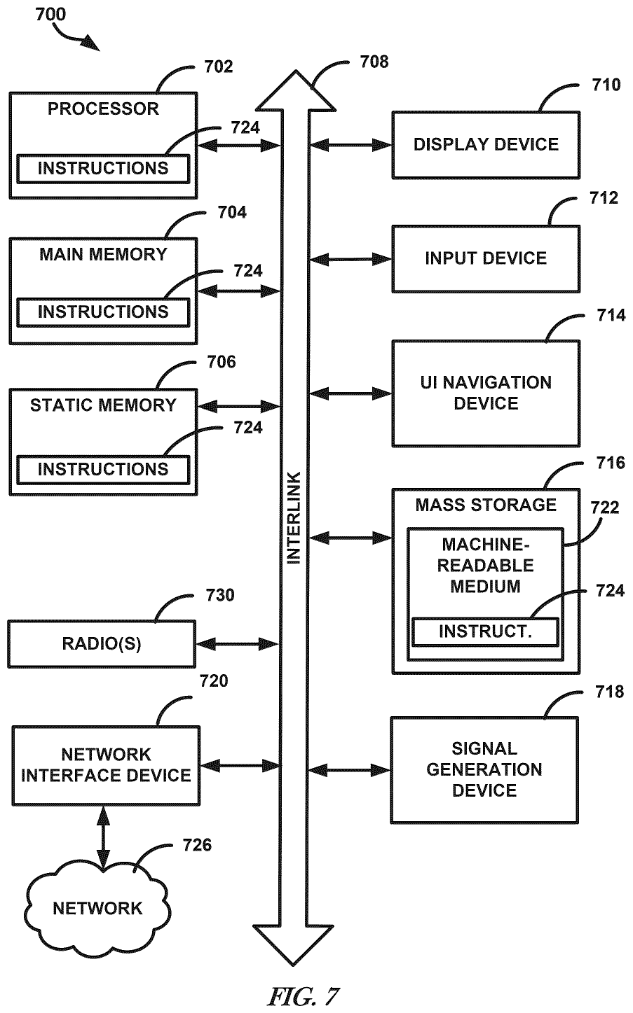

FIG. 7 illustrates, by way of example, a block diagram of an embodiment of a machine in the example form of a computer system 700 within which instructions, for causing the machine to perform any one or more of the methods or techniques discussed herein, may be executed. One or more of the user device 102, generative agent 104, 106, cycle detector 222, semantic extractor 220, prompt generator 238, operation 242, method 400, or other component, operation, or technique, can include, or be implemented or performed by one or more of the components of the computer system 700. In a networked deployment, the machine may operate in the capacity of a server or a client machine in server-client network environment, or as a peer machine in a peer-to-peer (or distributed) network environment. The machine may be a personal computer (PC), server, a tablet PC, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a mass storage unit 716, a signal generation device 718 (e.g., a speaker), a network interface device 720, and a radio 730 such as Bluetooth, WWAN, WLAN, and NFC, permitting the application of security controls on such protocols.

The mass storage unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding, or carrying instructions for execution by the machine, and includes digital or analog communications signals or other intangible media to facilitate communication of such software.

### Additional Examples

Example 1 includes a method for identifying cyclic behavior in a generative agent, the method comprising receiving, from the generative agent, a candidate completion, the candidate completion including a first response to a message from an entity conducting a conversation with the generative agent, determining, by a semantic extractor, a semantic embedding of the first response, and determining, by a cycle detector and based on the semantic embedding and prior embeddings, whether the first response is a repetition of a prior candidate completion in the conversation.

In Example 2, Example 1 further includes, responsive to determining the first response is the repetition, performing a mitigation action.

In Example 3, Example 2 further includes, wherein the mitigation action includes generating a prompt and providing the prompt to the generative agent, the prompt engineered to cause the generative agent to produce a second response that is not a repetition.

In Example 4, at least one of Examples 1-3 further includes, wherein the entity is another generative agent or a user device.

In Example 5, at least one of Examples 1˜4 further includes identifying that the first response includes a function call, incrementing a counter associated with a function of the function call, and determining the first response is a repetition if the counter is greater than a threshold value.

In Example 6, at least one of Examples 1-5 further includes, wherein the cycle detector is a trained machine learning (ML) model trained based on labelled conversation histories with generative agents.

In Example 7, at least one of Examples 1-6 further includes storing the semantic embedding in a semantic embedding database and wherein the cycle detector determines respective distances between the semantic embedding and prior semantic embeddings stored in the embedding database and determines the semantic embedding is the repetition if any of the respective distances satisfies a distance criterion.

In Example 8, Example 7 further includes, wherein the distance criterion is greater than a specified first threshold when the distance is a cosine similarity or is less than a specified second threshold when the distance is an angular distance.

In Example 9, at least one of Examples 1-8 further includes, wherein the semantic extractor determines multiple semantic embeddings for the first response, the multiple semantic embeddings including semantic embeddings for different length portions of the first response.

Example 10 includes a machine-readable medium including instructions that, when executed by a machine, cause the machine to perform operations for cycle detection in responses from a generative agent, the operations comprising receiving, from the generative agent, a candidate completion, the candidate completion including a first response to a message from an entity conducting a conversation with the generative agent, determining a semantic embedding of the first response, the semantic embedding including a projection of the first response to a semantic space in which semantically similar language is closer to each other than semantically different language, determining, based on the semantic embedding, whether the response is a repetition of a prior candidate completion in the conversation, and performing a mitigation action responsive to determining the response is the repetition.

In Example 11, Example 10 further includes, wherein the mitigation action includes generating a prompt and providing the prompt to the generative agent, the prompt engineered to cause the generative agent to produce a second, different response.

In Example 12, at least one of Examples 10-11 further includes, wherein the entity is another generative agent or a user device.

In Example 13, at least one of Examples 10-12 further includes, wherein the operations further comprise identifying that the first response includes a function call, incrementing a counter associated with a function of the function call, and determining the first response is a repetition if the counter is greater than a threshold value.

In Example 14, at least one of Examples 10-13 further includes, wherein a trained machine learning (ML) model trained based on labelled conversation histories with generative agents determines whether the response is a repetition.

In Example 15, at least one of Examples 10-14 further includes, wherein the operations further comprise storing the semantic embedding in a semantic embedding database and wherein the determining whether the response is a repetition includes determining respective distances between the semantic embedding and prior semantic embeddings stored in the embedding database and determines the semantic embedding is the repetition if any of the respective distances satisfies a distance criterion.

In Example 16, Example 15 further includes, wherein the distance criterion is greater than a specified first threshold when the distance is a cosine similarity or is less than a specified second threshold when the distance is an angular distance.

In Example 17, at least one of Examples 10-16 further includes determining multiple semantic embeddings for the first response, the multiple semantic embeddings including semantic embeddings for different length portions of the first response.

Example 18 includes a system for cycle detection in responses from a generative agent, the system comprising processing circuitry, at least one memory, the memory including instructions that, when executed by the processing circuitry, cause the processing circuitry to implement a semantic extractor configured to generate a semantic embedding of a first response from the generative agent during a conversation, the semantic embedding including a projection of the first response to a semantic space in which semantically similar language is closer than semantically different language, and a cycle detector configured to receive the semantic embedding and determine, based on the semantic embedding, whether the response is a repetition of a prior candidate completion in the conversation.

In Example 19, Example 18 further includes, wherein the instructions further include instructions that cause the processing circuitry to implement a prompt generator that generates a prompt and provides the prompt to the generative agent, the prompt engineered to cause the generative agent to produce a second, different response.

In Example 20, at least one of Examples 18-19 further includes a prior semantic vectors database, the semantic embedding is stored on the database and the cycle detector determines respective distances between the semantic embedding and prior semantic embeddings stored in the database and determines the semantic embedding is the repetition if any of the respective distances satisfies a distance criterion.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for identifying cyclic behavior in a generative agent, the method comprising:
receiving, from the generative agent, a candidate completion, the candidate completion including a first response to a message from an entity conducting a conversation with the generative agent;
determining, by a semantic extractor, a semantic embedding of the first response; and
determining, by a cycle detector and based on the semantic embedding and prior embeddings, whether the first response is a repetition of a prior candidate completion in the conversation.

2. The method of claim 1, further comprising responsive to determining the first response is the repetition, performing a mitigation action.

3. The method of claim 2, wherein the mitigation action includes generating a prompt and providing the prompt to the generative agent, the prompt engineered to cause the generative agent to produce a second response that is not a repetition.

4. The method of claim 1, wherein the entity is another generative agent or a user device.

5. The method of claim 1, further comprising:
identifying that the first response includes a function call;
incrementing a counter associated with a function of the function call; and
determining the first response is a repetition if the counter is greater than a threshold value.

6. The method of claim 1, wherein the cycle detector is a trained machine learning (ML) model trained based on labelled conversation histories with generative agents.

7. The method of claim 1, further comprising storing the semantic embedding in a semantic embedding database and wherein the cycle detector determines respective distances between the semantic embedding and prior semantic embeddings stored in the embedding database and determines the semantic embedding is the repetition if any of the respective distances satisfies a distance criterion.

8. The method of claim 7, wherein the distance criterion is greater than a specified first threshold when the distance is a cosine similarity or is less than a specified second threshold when the distance is an angular distance.

9. The method of claim 1, wherein the semantic extractor determines multiple semantic embeddings for the first response, the multiple semantic embeddings including semantic embeddings for different length portions of the first response.

10. A machine-readable medium including instructions that, when executed by a machine, cause the machine to perform operations for cycle detection in responses from a generative agent, the operations comprising:
receiving, from the generative agent, a candidate completion, the candidate completion including a first response to a message from an entity conducting a conversation with the generative agent;
determining a semantic embedding of the first response, the semantic embedding including a projection of the first response to a semantic space in which semantically similar language is closer to each other than semantically different language;
determining, based on the semantic embedding, whether the response is a repetition of a prior candidate completion in the conversation; and
performing a mitigation action responsive to determining the response is the repetition.

11. The machine-readable medium of claim 10, wherein the mitigation action includes generating a prompt and providing the prompt to the generative agent, the prompt engineered to cause the generative agent to produce a second, different response.

12. The machine-readable medium of claim 10, wherein the entity is another generative agent or a user device.

13. The machine-readable medium of claim 10, wherein the operations further comprise:
identifying that the first response includes a function call;
incrementing a counter associated with a function of the function call; and
determining the first response is a repetition if the counter is greater than a threshold value.

14. The machine-readable medium of claim 10, wherein a trained machine learning (ML) model trained based on labelled conversation histories with generative agents determines whether the response is a repetition.

15. The machine-readable medium of claim 10, wherein the operations further comprise storing the semantic embedding in a semantic embedding database and wherein the determining whether the response is a repetition includes determining respective distances between the semantic embedding and prior semantic embeddings stored in the embedding database and determines the semantic embedding is the repetition if any of the respective distances satisfies a distance criterion.

16. The machine-readable medium of claim 15, wherein the distance criterion is greater than a specified first threshold when the distance is a cosine similarity or is less than a specified second threshold when the distance is an angular distance.

17. The machine-readable medium of claim 10, further comprising determining multiple semantic embeddings for the first response, the multiple semantic embeddings including semantic embeddings for different length portions of the first response.

18. A system for cycle detection in responses from a generative agent, the system comprising:
processing circuitry; and
at least one memory, the memory including instructions that, when executed by the processing circuitry, cause the processing circuitry to implement:
a semantic extractor configured to generate a semantic embedding of a first response from the generative agent during a conversation, the semantic embedding including a projection of the first response to a semantic space in which semantically similar language is closer than semantically different language; and
a cycle detector configured to receive the semantic embedding and determine, based on the semantic embedding, whether the response is a repetition of a prior candidate completion in the conversation.

19. The system of claim 18, wherein the instructions further include instructions that cause the processing circuitry to implement a prompt generator that generates a prompt and provides the prompt to the generative agent, the prompt engineered to cause the generative agent to produce a second, different response.

20. The system of claim 18, further comprising a prior semantic vectors database, the semantic embedding is stored on the database and the cycle detector determines respective distances between the semantic embedding and prior semantic embeddings stored in the database and determines the semantic embedding is the repetition if any of the respective distances satisfies a distance criterion.
